(19) United States
(12) Patent Application Publication
(10) Pub. No.: US 2024/0406833 A1
(43) Pub. Date: Dec. 5, 2024

(54) SCG-MAINTAINED CONDITIONAL HANDOVER IN DUAL CONNECTIVITY WITH SCG FAILURE

(71) Applicant: Nokia Technologies Oy, Espoo (FI)

(72) Inventors: Faranaz SABOURI-SICHANI, Aalborg (DK); Srinivasan SELVAGANAPATHY, Bangalore (IN); Ahmad AWADA, Munich (DE); Subramanya CHANDRASHEKAR, Bangalore (IN)

(21) Appl. No.: 18/691,095

(22) PCT Filed: Sep. 16, 2022
(86) PCT No.: PCT/EP2022/075756

§ 371 Date: Mar. 12, 2024

(30) Foreign Application Priority Data
Sep. 21, 2021 (IN) 202141042684

(51) Int. Cl. H04W 36/36; H04W 36/00; H04W 36/30

(52) U.S. Cl. CPC H04W 36/362; H04W 36/0085; H04W 36/305

(57) ABSTRACT

Techniques of configuring and executing CHO include including in a RRC reconfiguration of the UE, during a CHO configuration process in which a PSCell is unchanged, include (i) an indicator indicating that the secondary cell group (SCG) remains the same after the CHO has been executed and (ii) a value SCG and determining whether a user equipment (UE) should attempt to access the SCG after execution of the CHO has begun.

### TECHNICAL FIELD

This description relates to communications.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3^{rd} Generation Partnership Project (3GPP). A recent development in this field is often referred to as the long-term evolution (LTE) of the Universal Mobile Telecommunications System (UMTS) radio-access technology. E-UTRA (evolved UMTS Terrestrial Radio Access) is the air interface of 3GPP's LTE upgrade path for mobile networks. In LTE, base stations or access points (APs), which are referred to as enhanced Node AP (eNBs), provide wireless access within a coverage area or cell. In LTE, mobile devices, or mobile stations are referred to as user equipment (UE). LTE has included a number of improvements or developments.

A global bandwidth shortage facing wireless carriers has motivated the consideration of the underutilized millimeter wave (mmWave) frequency spectrum for future broadband cellular communication networks, for example. mmWave (or extremely high frequency) may, for example, include the frequency range between 30 and 300 gigahertz (GHz). Radio waves in this band may, for example, have wavelengths from ten to one millimeters, giving it the name millimeter band or millimeter wave. The amount of wireless data will likely significantly increase in the coming years. Various techniques have been used in attempt to address this challenge including obtaining more spectrum, having smaller cell sizes, and using improved technologies enabling more bits/s/Hz. One element that may be used to obtain more spectrum is to move to higher frequencies, e.g., above 6 GHz. For fifth generation wireless systems (5G), an access architecture for deployment of cellular radio equipment employing mmWave radio spectrum has been proposed. Other example spectrums may also be used, such as cmWave radio spectrum (e.g., 3-30 GHz).

### SUMMARY

According to an example implementation, a method includes transmitting, by a source master node within a network to a target master node within the network, request data representing a request to prepare execution of a conditional handover involving a user equipment served by the source master node and a source secondary node. The method also includes receiving, by the source master node from the target master node, response data representing configuration information for a secondary cell group associated with a target secondary node and the target master node, the configuration information including an indicator indicating that a primary secondary cell of the secondary cell group remains the same after an execution of the conditional handover. The method further includes transmitting, by the master source node to the user equipment, configuration data representing (i) the configuration information for the secondary cell group and (ii) a value of at least one parameter, the at least one parameter causing the user equipment to control reporting of a radio link failure at the secondary cell group and before the execution of the conditional handover has begun. The method further includes, after transmitting the configuration data to the user equipment, receiving, by the source master node from the user equipment, failure data indicating that the user equipment detected a radio link failure at the secondary cell. The method further includes determining, by the source master node, an action to take to respond to the detected radio link failure at the secondary cell group, the action being based on the configuration information for the secondary cell group.

According to an example implementation, an apparatus includes at least one processor and at least one memory including computer program code, the at least one memory and the computer program code configured to, with the at least one processor, cause the apparatus at least to transmit, by a source master node within a network to a target master node within the network, request data representing a request to prepare execution of a conditional handover involving a user equipment served by the source master node and a source secondary node. The at least one memory and the computer program code are also configured to, with the at least one processor, cause the apparatus at least to receive, by the source master node from the target master node, response data representing configuration information for a secondary cell group associated with a target secondary node and the target master node, the configuration information including an indicator indicating that a primary secondary cell of the secondary cell group remains the same after an execution of the conditional handover. The at least one memory and the computer program code are further configured to, with the at least one processor, cause the apparatus at least to transmit, by the master source node to the user equipment, configuration data representing (i) the configuration information for the secondary cell group and (ii) a value of at least one parameter, the at least one parameter causing the user equipment to control reporting of a radio link failure at the secondary cell group and before the execution of the conditional handover has begun. The at least one memory and the computer program code are further configured to, with the at least one processor, cause the apparatus at least to, after transmitting the configuration data to the user equipment, receive, by the source master node from the user equipment, failure data indicating that the user equipment detected a radio link failure at the secondary cell group. The at least one memory and the computer program code are further configured to, with the at least one processor, cause the apparatus at least to determine, by the source master node, an action to take to respond to the detected radio link failure at the secondary cell group, the action being based on the configuration information for the secondary cell group.

According to an example implementation, an apparatus includes means for transmitting, by a source master node within a network to a target master node within the network, request data representing a request to prepare execution of a conditional handover involving a user equipment served by the source master node and a source secondary node. The apparatus also includes means for receiving, by the source master node from the target master node, response data representing configuration information for a secondary cell group associated with a target secondary node and the target master node, the configuration information including an indicator indicating that a primary secondary cell of the secondary cell group remains the same after an execution of the conditional handover. The apparatus further includes means for transmitting, by the master source node to the user equipment, configuration data representing (i) the configuration information for the secondary cell group and (ii) a value of at least one parameter, the at least one parameter causing the user equipment to control reporting of a radio link failure at the secondary cell group and before the execution of the conditional handover has begun. The apparatus further includes means for, after transmitting the configuration data to the user equipment, receiving, by the source master node from the user equipment, failure data indicating that the user equipment detected a radio link failure at the secondary cell. The apparatus further includes means for determining, by the source master node, an action to take to respond to the detected radio link failure at the secondary cell group, the action being based on the configuration information for the secondary cell group.

According to an example implementation, a computer program product includes a computer-readable storage medium and storing executable code that, when executed by at least one data processing apparatus, is configured to cause the at least one data processing apparatus to transmit, by a source master node within a network to a target master node within the network, request data representing a request to prepare execution of a conditional handover involving a user equipment served by the source master node and a source secondary node. The executable code, when executed by at least one data processing apparatus, is also configured to cause the at least one data processing apparatus to receive, by the source master node from the target master node, response data representing configuration information for a secondary cell group associated with a target secondary node and the target master node, the configuration information including an indicator indicating that a primary secondary cell of the secondary cell group remains the same after an execution of the conditional handover. The executable code, when executed by at least one data processing apparatus, is further configured to cause the at least one data processing apparatus to transmit, by the master source node to the user equipment, configuration data representing (i) the configuration information for the secondary cell group and (ii) a value of at least one parameter, the at least one parameter causing the user equipment to control reporting of a radio link failure at the secondary cell group and before the execution of the conditional handover has begun. The executable code, when executed by at least one data processing apparatus, is further configured to cause the at least one data processing apparatus to, after transmitting the configuration data to the user equipment, receive, by the source master node from the user equipment, failure data indicating that the user equipment detected a radio link failure at the secondary cell group. The executable code, when executed by at least one data processing apparatus, is further configured to cause the at least one data processing apparatus to determine, by the source master node, an action to take to respond to the detected radio link failure at the secondary cell group, the action being based on the configuration information for the secondary cell group.

According to an example implementation, a method includes receiving, by a user equipment served by a source master node and a source secondary node as part of a conditional handover to a target master node and a source secondary node, configuration data representing (i) configuration information for a secondary cell group associated with the target secondary node and the target master node, and (ii) a value of at least one parameter, the configuration information including an indication that a primary secondary cell of the secondary cell group remains the same after an execution of the conditional handover, the at least one parameter causing the user equipment to control reporting of a radio link failure at the secondary cell group before the execution of the conditional handover has begun. The method also includes detecting, by the user equipment, a radio link failure at the secondary cell group. The method further includes, after detecting the radio link failure, performing, by the user equipment, measurements of a signal quality metric at the secondary cell group.

According to an example implementation, an apparatus includes at least one processor and at least one memory including computer program code, the at least one memory and the computer program code configured to, with the at least one processor, cause the apparatus at least to receive, by a user equipment served by a source master node and a source secondary node as part of a conditional handover to a target master node and a source secondary node, configuration data representing (i) configuration information for a secondary cell group associated with the target secondary node and the target master node, and (ii) a value of at least one parameter, the configuration information including an indication that a primary secondary cell of the secondary cell group remains the same after an execution of the conditional handover, the at least one parameter causing the user equipment to control reporting of a radio link failure at the secondary cell group before the execution of the conditional handover has begun. The at least one memory and the computer program code are also configured to detect, by the user equipment, a radio link failure at the secondary cell group. The at least one memory and the computer program code are further configured to, after detecting the radio link failure, perform, by the user equipment, measurements of a signal quality metric at the secondary cell group.

According to an example implementation, an apparatus includes means for receiving, by a user equipment served by a source master node and a source secondary node as part of a conditional handover to a target master node and a source secondary node, configuration data representing (i) configuration information for a secondary cell group associated with the target secondary node and the target master node, and (ii) a value of at least one parameter, the configuration information including an indication that a primary secondary cell of the secondary cell group remains the same after an execution of the conditional handover, the at least one parameter causing the user equipment to control reporting of a radio link failure at the secondary cell group before the execution of the conditional handover has begun. The apparatus also includes means for detecting, by the user equipment, a radio link failure at the secondary cell group. The apparatus further includes means for, after detecting the radio link failure, performing, by the user equipment, measurements of a signal quality metric at the secondary cell group.

According to an example implementation, a computer program product includes a computer-readable storage medium and storing executable code that, when executed by at least one data processing apparatus, is configured to cause the at least one data processing apparatus to receive, by a user equipment served by a source master node and a source secondary node as part of a conditional handover to a target master node and a source secondary node, configuration data representing (i) configuration information for a secondary cell group associated with the target secondary node and the target master node, and (ii) a value of at least one parameter, the configuration information including an indication that a primary secondary cell of the secondary cell group remains the same after an execution of the conditional handover, the at least one parameter causing the user equipment to control reporting of a radio link failure at the secondary cell group before the execution of the conditional handover has begun. The executable code, when executed by at least one data processing apparatus, is also configured to cause the at least one data processing apparatus to detect, by the user equipment, a radio link failure at the secondary cell group. The executable code, when executed by at least one data processing apparatus, is also configured to cause the at least one data processing apparatus to, after detecting the radio link failure, perform, by the user equipment, measurements of a signal quality metric at the secondary cell group.

The details of one or more examples of implementations are set forth in the accompanying drawings and the description below. Other features will be apparent from the description and drawings, and from the claims.

### BRIEF DESCRIPTION OF THE DRAWINGS

FIG. 1 is a block diagram of a digital communications network according to an example implementation.

FIG. 2 is a sequence diagram illustrating a scenario in which there is a SCG failure upon PCell CHO execution according to an example implementation.

FIG. 3 is a sequence diagram illustrating a process of CHO configuration when the UE detects a SCG failure, according to an example implementation.

FIG. 4 is a sequence diagram illustrating a process of CHO execution when the UE detects a SCG failure according to an example implementation.

FIG. 5 is a sequence diagram illustrating a process of CHO execution when the UE detects a SCG failure according to an example implementation.

FIG. 6 is a flow chart illustrating a process of CHO configuration when the UE detects a SCG failure according to an example implementation

FIG. 7 is a flow chart illustrating a process of CHO configuration when the UE detects a SCG failure according to an example implementation.

FIG. 8 is a block diagram of a node or wireless station (e.g., base station/access point, relay node, or mobile station/user device) according to an example implementation.

### DETAILED DESCRIPTION

The principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

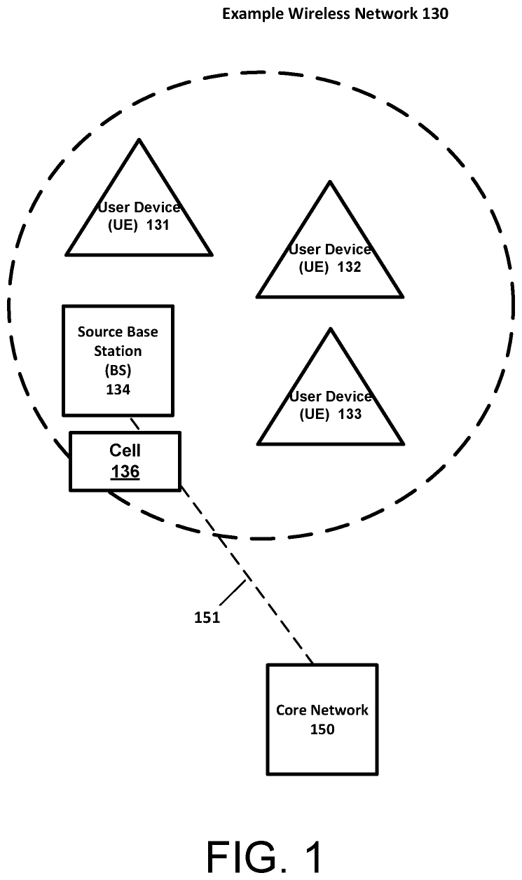

FIG. 1 is a block diagram of a digital communications system such as a wireless network 130 according to an example implementation. In the wireless network 130 of FIG. 1, user devices 131, 132, and 133, which may also be referred to as mobile stations (MSs) or user equipment (UEs), may be connected (and in communication) with a base station (BS) 134, which may also be referred to as an access point (AP), an enhanced Node B (eNB), a gNB (which may be a 5G base station) or a network node. At least part of the functionalities of an access point (AP), base station (BS) or (e)Node B (eNB) may be also be carried out by any node, server or host which may be operably coupled to a transceiver, such as a remote radio head. BS (or AP) 134 provides wireless coverage within a cell 136, including the user devices 131, 132 and 133. Although only three user devices are shown as being connected or attached to BS 134, any number of user devices may be provided. BS 134 is also connected to a core network 150 via an interface 151. This is merely one simple example of a wireless network, and others may be used.

A user device (user terminal, user equipment (UE)) may refer to a portable computing device that includes wireless mobile communication devices operating with or without a subscriber identification module (SIM), including, but not limited to, the following types of devices: a mobile station (MS), a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, a vehicle, and a multimedia device, as examples. It should be appreciated that a user device may also be a nearly exclusive uplink only device, of which an example is a camera or video camera loading images or video clips to a network.

In LTE (as an example), core network 150 may be referred to as Evolved Packet Core (EPC), which may include a mobility management entity (MME) which may handle or assist with mobility/serving cell change of user devices between BSs, one or more gateways that may forward data and control signals between the BSs and packet data networks or the Internet, and other control functions or blocks.

The various example implementations may be applied to a wide variety of wireless technologies, wireless networks, such as LTE, LTE-A, 5G (New Radio, or NR), cmWave, and/or mmWave band networks, or any other wireless network or use case. LTE, 5G, cmWave and mmWave band networks are provided only as illustrative examples, and the various example implementations may be applied to any wireless technology/wireless network. The various example implementations may also be applied to a variety of different applications, services or use cases, such as, for example, ultra-reliability low latency communications (URLLC), Internet of Things (IoT), time-sensitive communications (TSC), enhanced mobile broadband (eMBB), massive machine type communications (MMTC), vehicle-to-vehicle (V2V), vehicle-to-device, etc. Each of these use cases, or types of UEs, may have its own set of requirements.

The handover (HO) procedure for user equipment (UE) having dual connectivity (DC) is defined for the cases when the master cell group (MCG) is to be changed with or without secondary node (SN) change. Inter-Master Node (MN) handover with/without MN initiated SN change is used to transfer UE context data from a source MN to a target MN while the UE context at the SN is kept or moved to another SN. During an inter-MN handover, the target MN decides whether to keep or change the SN. There is a procedure for inter-MN handover with/without MN initiated SN change.

A conditional HO (CHO) procedure can also be used when the UE is having DC at the time of CHO preparation. In this case, the CHO preparation of target cell may consider including the same secondary cell group (SCG) in the preparation. When CHO is executed to target MN, the UE should release the source MN and source SN. The UE should then re-access the (same or different) SN which is configured as part of the CHO configuration.

Procedures for CHO with/without SN change are not yet defined. It is assumed that a source SN release request and SN release ACK are performed after a source MN receives an indication from a target MN that the UE has successfully accessed one of the potential target MNs (i.e. after the target MN receives a RRCReconfigurationComplete message from the UE).

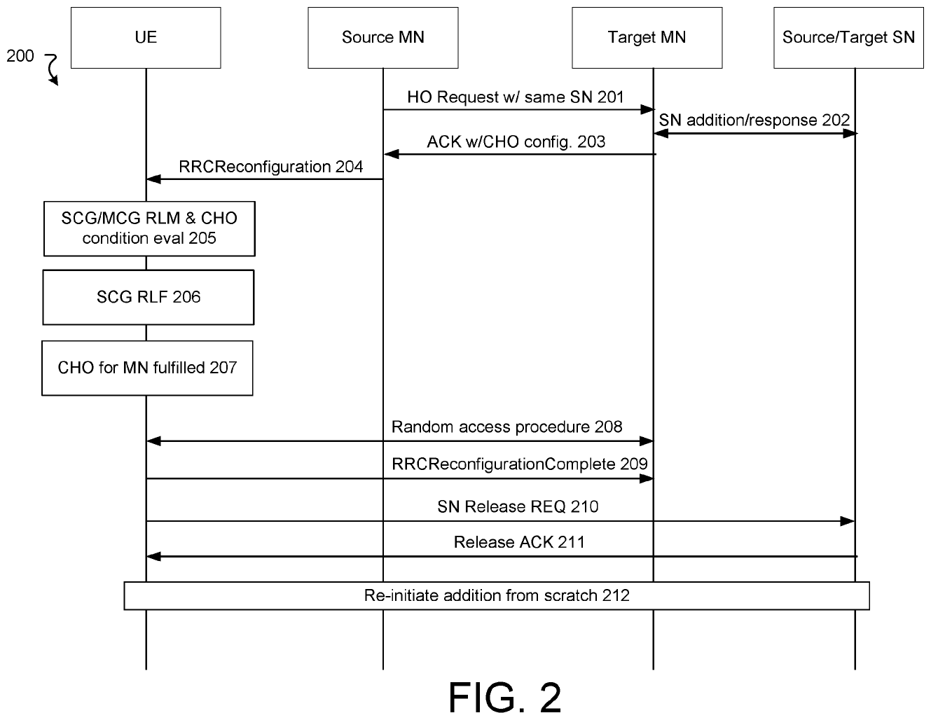

FIG. 2 is a sequence diagram illustrating a scenario 200 in which there is a SCG failure upon PCell CHO execution.

At 201, the source MN transmits a HO request to a target MN, such that the source and target SNs are the same SN.

At 202, the target MN transmits a SN addition request to the SN, which in turn transmits a response back to the target MN.

At 203, the target MN transmits an ACK with a CHO configuration to the source MN.

At 204, the source MN transmits a RRCReconfiguration message to the UE.

At 205, the UE evaluates conditions under which the CHO is executed, and performs a RLM operation on the SCG/MCG.

At 206, the UE detects a RLF at the SCG.

At 207, the UE determines that the conditions for CHO for the MN are fulfilled. In case SCG failure (Secondary Cell Group controlled by source SN) is detected before/upon PCell CHO execution, the current behavior expects the UE to attempt a re-access of the SN based on the received configuration in CHO command and fails. Consequently, the target MN needs to reinitiate the whole process of SN addition.

At 208, the UE and target MN perform a random access procedure.

At 209, the UE sends the target MN a RRCReconfigurationComplete message.

At 210, the UE transmits a SN release request to the SN.

At 211, the SN transmits a release acknowledgment to the UE.

At 212, the SN addition process is re-initiated.

This re-initiation of the SN addition process introduces additional delay in SN addition.

In contrast to the above-described conventional approaches to configuring and executing CHO, an improved technique of configuring and executing CHO includes including in a RRC reconfiguration of the UE, during a CHO configuration process in which a PSCell is unchanged, include (i) an indicator indicating that the secondary cell group (SCG) remains the same after the CHO has been executed and (ii) a value of at least one parameter controlling reporting of a radio link failure (RLF) at the SCG and determining whether a user equipment (UE) should attempt to access the SCG after execution of the CHO has begun. In some implementations, the parameter includes an indication indicating that the UE shall not report the RLF at the SCG in response to the detection of the RLF at the SCG occurring prior to the execution of the CHO. In some implementations, the parameter includes an amount of time allotted for the UE to receive new configuration data for the SCG after the UE sends a RRC Reconfiguration Complete message to the target MN. In some implementations, the parameter includes a signal quality threshold as measured by the UE at a PSCell.

Advantageously, the above-described improved technique for configuring and executing a CHO saves time by avoiding a re-initiation of a secondary node addition in response to a RLF at the SCG when the SCG is unchanged after execution of the CHO. The improved techniques enable faster target reconfiguration of SCG via the following.
The network (NW) adds a flag to the CHO including SCG configuration indicating the SCG configuration is with the same PSCell as in the source configuration.
In case of CHO execution after S-RLF at source node, UE action on whether to start RACH procedure with target SCG is controlled by NW configured conditions—signal strength/quality threshold X and timer T for awaiting NW response for Handover complete before RACH-Access to SCG.

Regarding failure reporting and recovery preparation:
Upon SCG failure (S-RLF) detection (before CHO execution), the failure report is generated by the UE and transmitted to the source MN together with SCG measurements.
The UE continues SCG measurements after failure reporting.
The UE as well as source MN are aware that the SCG configuration contained in CHO is with the same PSCell i.e. the PScell remains unchanged before and after CHO.

There are three options for source MN actions after failure reporting:
Option 1
   Source MN forwards the SCG-Failure-Information to Target MN via new Inter-node message.
   The preparation of new SCG is triggered by target MN who receives the SCG failure report including SCG measurements from source MN. New SCG configuration with same SN denoted by SN1, or a new SN, denoted by SN2, is prepared.
   Target MN provides a new CHO configuration with updated SCG configuration to source MN, and source MN transmits the configuration to the UE.
Option 2
   The source MN forwards the SCG-Failure-Information to source/target SN1.
   The preparation of new SCG is triggered by source/target SN1.
   SN1 informs the modified SCG configuration to be used after handover to Target MN via new inter-node message.
   In some implementations, the target MN may decide to configure the SN in a deactivated state (this is applicable when there is no other good PSCell, as seen by the UE and the target MN wants to configure DC to the UE)
   Subsequently, a new measurement report (pertaining to SCG) may reactivate the deactivated SN (post CHO).
   The target MN provides a new CHO configuration with updated SCG configuration to source MN, and source MN transmits the configuration to the UE.
Option 3
   The source MN decides not to take any action upon the reception of SCG failure.

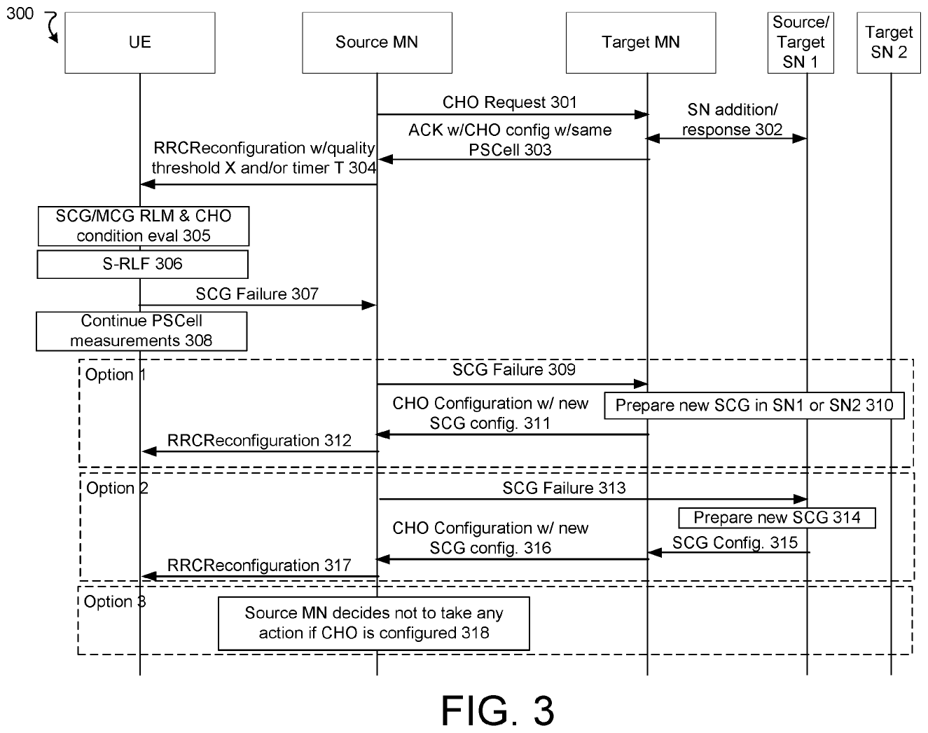

FIG. 3 is a sequence diagram illustrating a process of CHO configuration when the UE detects a SCG failure.

At 301 and 302, a UE is in dual connectivity with source MN and source SN (SN1). Source MN request condition HO toward a selected target MN. Target MN decides to add an SN and prepares the configuration with same PSCell from SN., i.e., both the source and target SN are the same.

At 303, the target MN provides the configuration to source MN and adds a new flag indicating that the target SCG configuration has the same PSCell as source SCG configuration.

At 304, the configuration is sent to the UE and may also include signal level/quality threshold, X, and timer, T, to be used at the UE to decide whether/when it should attempt RACH access to SCG after successful CHO to target MN even after SCG failure was detected.

At 305, the UE continues to perform radio link monitoring of MCG and SCG and starts evaluation of CHO condition for PCell.

At 306, the UE detects RLF for the SCG.

At 307, the UE transmits a failure report to the source MN.

At 308, the UE continues to perform radio resource management (RRM) measurements on the PSCell after S-RLF.

### Option 1:

At 309, the source MN forwards the SCG failure report to the target MN using a new inter-node message.

At 310, the target MN prepares an updated SCG configuration at current source/target SN, SN1, or a new target/source SN, SN2.

At 311 and 312, the target MN transmits an updated CHO configuration with new SCG configuration to source MN and the source MN provides the updated CHO configuration to the UE.

### Option 2:

At 313, the source MN transmits the SCG failure report to the source/target SN1.

At 314 and 315, the source/target SN1 prepares a new SCG and transmits the new configuration to target MN via a new inter-node message.

At 316 and 317, the updated CHO configuration with new SCG configuration is sent to source MN by target MN and provided to the UE by source MN.

### Option 3:

At 318, the source MN decides not to take any further action as CHO is configured.

Regarding CHO execution and SCG access:
In case the new CHO command with updated SCG configuration is received by the UE before former CHO condition is met and corresponding execution is started, the CHO configuration will be replaced, and the CHO execution will be carried out as specified in 3GPP.
In case the original CHO condition is met before the new updated CHO command is sent by the network to the UE, the UE starts the CHO execution and does not receive the new CHO command via the source MN.
   At completion of the target MN access, the UE starts the configured—or fixed specified-timer, T.
   The target MN transmits the RRCReconfiguration with the new prepared SCG to the UE upon reception of the RRCReconfigurationComplete on target PCell.
   If the UE receives the reconfiguration while timer T is still running, the UE stops the timer and proceed with SCG access to the configured PSCell (from SN1 or SN2).
   If the timer T expires and the UE has not received new SCG configuration it will evaluate the measured PSCell measured signal level/quality against threshold X.
   If PSCell signal strength/quality e.g., RSRP/RSRQ<Threshold X, UE does not perform access to PSCell and informs target MN with cause ‘RACH to PSCell skipped.’ Else, the UE performs RACH access to PSCell.

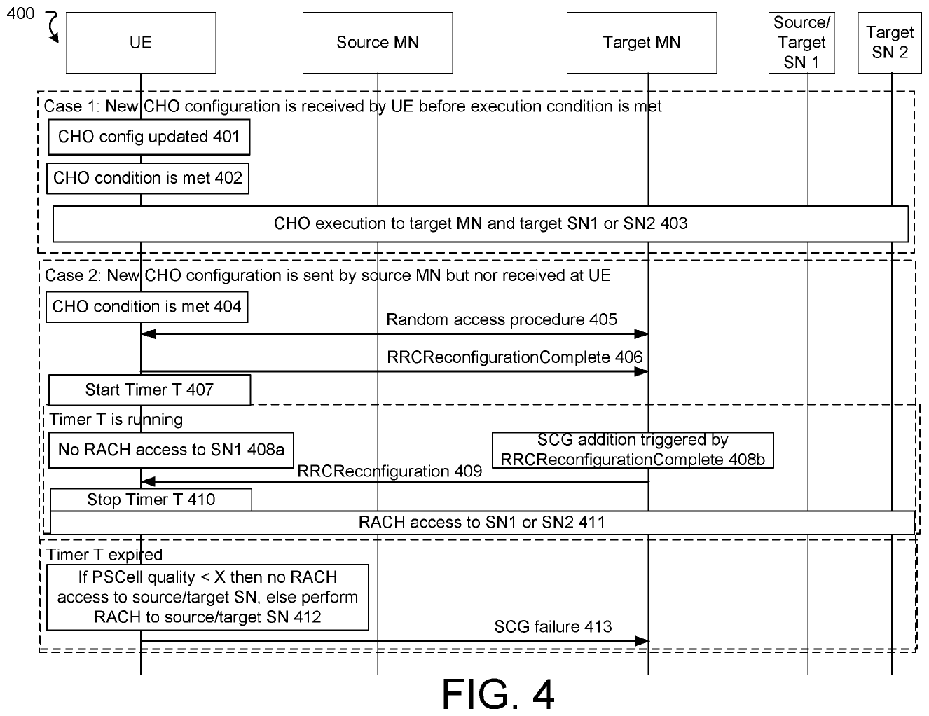

FIG. 4 is a flow chart illustrating a process 400 of CHO execution when the UE detects a SCG failure. It is assumed that the CHO has the same PSCell configured, the SCG failure is detected and reported, and a new SCG is available at the target MN.

### Case 1:

At 401, 402, and 403, if the new CHO configuration is sent and received by the UE before the former CHO condition is met, the UE replaces the configuration and proceeds with access to target PCell and the new configured PSCell.

### Case 2:

At 404, 405, and 406, if the former CHO condition is met and the UE has started execution the new CHO configuration sent by source MN is not received at the UE as it has detached from source MN, the UE proceeds with target PCell access and completes.

At 407, the UE starts timer T after sending RRC Reconfiguration Complete message to the target PCell. The timer may be a fixed preconfigured timer or configured in CHO command transmitted to the UE. NW may configure the timer depending on estimate of the time taken for the target PCell to send a new RRC Reconfiguration message.

At 408a and 408b, upon receipt of RRCReconfigurationComplete for PCell, target MN, which has already a prepared new target SCG configuration, triggers the SN addition by transmitting the configuration of the new SCG to the UE. The UE will not do RACH access to source/target SN1 while the timer is running.

At 409, the target MN transmits RRCReconfiguration to the UE with the new SCG configuration.

At 410 and 411, upon reception of the RRC Reconfiguration from target PCell, the UE stops timer T and proceeds with RACH access to SN1 or SN2.

At 412 and 413, if the timer T expires and the UE has not received a configuration with new SCG (the case when target PCell did not prepare a new SCG), UE will evaluate the measured PSCell signal level/quality (RSRP/RSRQ) against the configured threshold X.
If PSCell RSRP/RSRQ<Threshold X, i.e. the SCG channel condition has not improved, the UE will not perform access to PSCell and informs target MN using a new cause ‘RACH to PSCell skipped’ in SCG Failure report sent to target MN.
Else, the UE performs RACH access to the PSCell and follow existing procedure upon success or failure.

In some implementations, target SCG access after CHO for S-RLF is modified (i.e., no reconfiguration triggered by the NW).
If the source MN decides not to trigger any source SCG change or Target configuration change on S-RLF triggered during SCG maintained CHO.
The source MN indicates the same to UE via RRC signalling at the time of CHO configuration with SCG addition. Source MN may also indicate the conditions for reporting the SCG-Failure to target MN as part of this signalling. This condition may refer to SCG radio channel condition, e.g. measured RSRP/RSRQ.
In this case, on detection of S-RLF, UE does not trigger SCG-Failure-Information to source MN.
If the CHO execution is triggered towards Target MN having same SCG, UE includes the SCG-Failure-Indication in the handover-complete message, if the conditions for reporting SCG-Failure to Target node is met, i.e., if the target PSCell RSRP/RSRQ is below a threshold X which is provided by the network. In this case SCG-RACH access is not triggered after sending Handover complete.
Otherwise, the UE continues with Target SCG access after the handover complete.

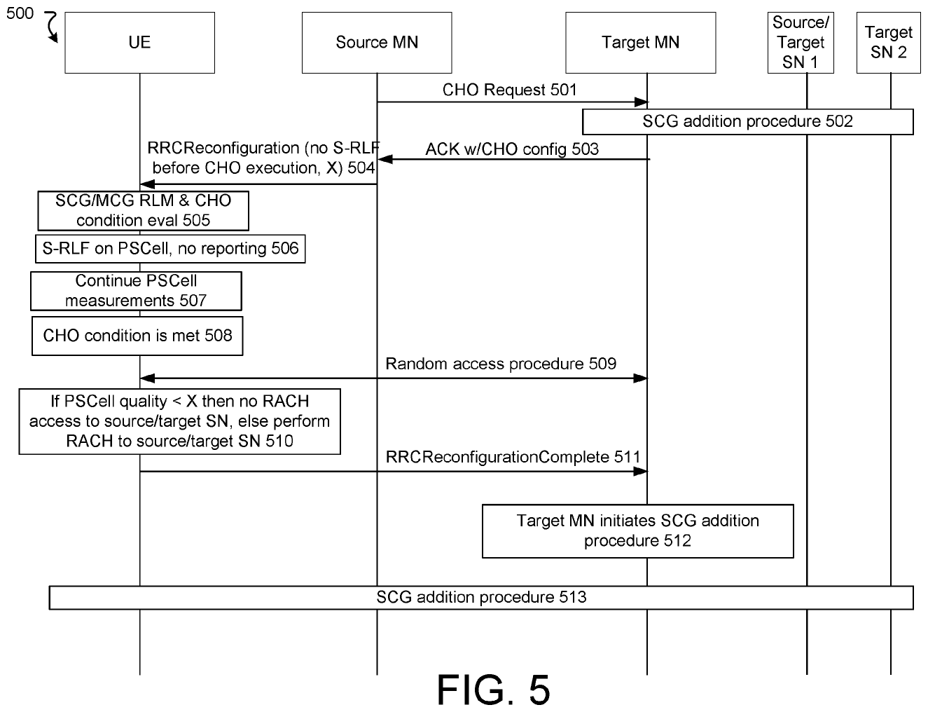

FIG. 5 is a sequence diagram illustrating a process 500 of CHO execution when the UE detects a SCG failure. The following corresponds to Option 3 in the preparation phase.

At 501, 502, and 503, a UE is in dual connectivity with source MN and source SN (SN1). Source MN request condition HO toward a selected target MN. Target MN decides to add an SN and prepares the configuration together with CHO.

At 504, the configuration is sent to the UE by source MN and may also include indication that the UE does not need to report an SCG failure that may occur before CHO execution. Target MN may also add a threshold X, to be used as condition for reporting the SCG-Failure to target.

At 505, 506, 507, the UE continues radio link monitoring and evaluation of CHO condition. In case SCG failure is observed, the UE will not transmit any SCG failure report to source MN. UE continues PSCell RRM measurements after S-RLF.

At 508 and 509, the CHO condition is met, and the UE proceeds RACH access to target PCell.

At 510 and 511, when the PCell access completes and the timer is still running, UE will evaluate the measured PSCell signal level/quality (RSRP/RSRQ) against the configured threshold.
If PSCell RSRP/RSRQ<Threshold X, i.e. the SCG channel condition has not improved, the UE will not attempt access to PSCell and append SGG failure report to the RRCReconfiguration message. Target MN may initiate preparation of new SCG for SCG addition.
Else, the UE performs RACH access to PSCell according to the CHO. configuration in step 4 and follow existing procedure upon success or failure.

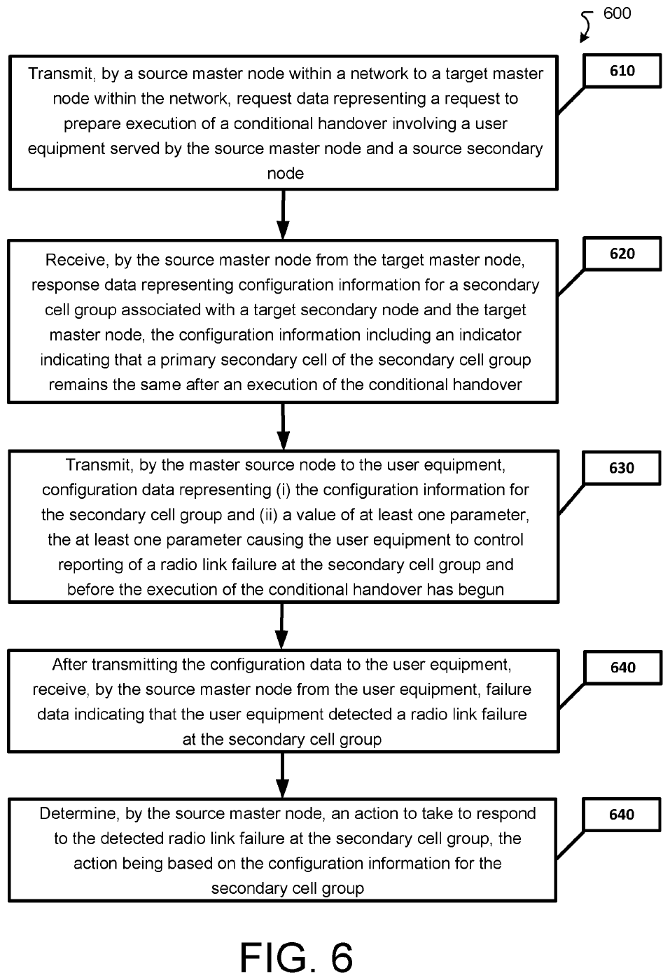

Example 1-1: FIG. 6 is a flow chart illustrating a process 600 of CHO configuration when the UE detects a SCG failure. Operation 610 includes transmitting, by a source master node within a network to a target master node within the network, request data representing a request to prepare execution of a conditional handover involving a user equipment served by the source master node and a source secondary node. Operation 620 includes receiving, by the source master node from the target master node, response data representing configuration information for a secondary cell group associated with a target secondary node and the target master node, the configuration information including an indicator indicating that a primary secondary cell of the secondary cell group remains the same after an execution of the conditional handover. Operation 630 includes transmitting, by the master source node to the user equipment, configuration data representing (i) the configuration information for the secondary cell group and (ii) a value of at least one parameter, the at least one parameter causing the user equipment to control reporting of a radio link failure at the secondary cell group and before the execution of the conditional handover has begun. Operation 640 includes, after transmitting the configuration data to the user equipment, receiving, by the source master node from the user equipment, failure data indicating that the user equipment detected a radio link failure at the secondary cell. Operation 650 includes determining, by the source master node, an action to take to respond to the detected radio link failure at the secondary cell group, the action being based on the configuration information for the secondary cell group.

Example 1-2: According to an example implementation of example 1-1, wherein the action includes forwarding the failure data to the target master node.

Example 1-3: According to an example implementation of examples 1-1 or 1-2, wherein the action includes forwarding the failure data to the target secondary node, which is the same as target secondary node.

Example 1-4: According to an example implementation of examples 1-1 to 1-3, wherein the action includes discarding the failure data.

Example 1-5: According to an example implementation of examples 1-1 to 1-4, wherein the failure data includes measurement data representing measurements of the primary secondary cell performed by the user equipment, the measurements being made by the user equipment after the user equipment detected the radio link failure at the secondary cell group.

Example 1-6: According to an example implementation of examples 1-1 to 1-5, wherein the parameter includes an indication indicating that the user equipment shall not report the radio link failure at the secondary cell group in response to the detection of the radio link failure at the secondary cell group occurring prior to the execution of the conditional handover.

Example 1-7: According to an example implementation of examples 1-1 to 1-6, wherein the parameter includes an amount of time allotted for the user equipment to receive new configuration data for the secondary cell group after the user equipment sends a RRC Reconfiguration Complete message to the target master node.

Example 1-8: According to an example implementation of example 1-7, wherein the amount of time is based on an estimate of an amount of time taken for a target primary cell to send a new RRC Reconfiguration message to the user equipment.

Example 1-9: According to an example implementation of examples 1-1 to 1-8, wherein the parameter includes a signal quality threshold as measured by the user equipment at a primary secondary cell.

Example 1-10: According to an example implementation of examples 1-1 to 1-9, wherein the configuration information for the secondary cell group indicates support for the secondary node for a change in a configuration of the secondary cell group.

Example 1-11: According to an example implementation of examples 1-1 to 1-10, wherein any of (i) the parameter including an amount of time allotted for the user equipment to receive new configuration data for the secondary cell group after the user equipment sends a RRC Reconfiguration Complete message to the master target node, (ii) the parameter including a signal quality threshold as measured by the user equipment at a primary secondary cell, or (iii) the configuration information for the secondary cell group indicating support for the secondary node for a change in a configuration of the secondary cell, occurs in response to a new conditional handover command with updated secondary cell group configuration not being delivered to the user equipment before the conditional handover is executed.

Example 1-12: According to an example implementation of examples 1-1 to 1-11, wherein the action to take to respond to the detected radio link failure at the secondary cell group is determined based on whether a measurement of the primary secondary cell reported in a secondary cell group failure report is served by the same secondary node as the secondary node to which a source primary secondary cell belongs.

Example 1-13: An apparatus comprising means for performing a method of any of examples 1-1 to 1-12.

Example 1-14: A computer program product including a non-transitory computer-readable storage medium and storing executable code that, when executed by at least one data processing apparatus, is configured to cause the at least one data processing apparatus to perform a method of any of examples 1-1 to 1-12.

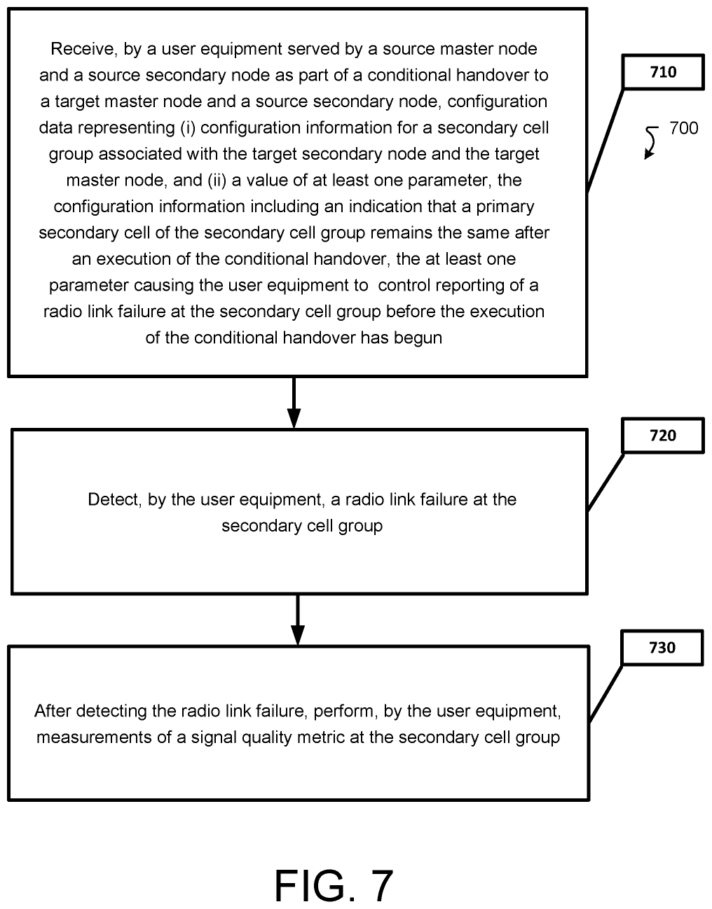

Example 2-1: FIG. 7 is a flow chart illustrating a process 700 of updating an ML model. Operation 710 includes receiving, by a user equipment served by a source master node and a source secondary node as part of a conditional handover to a target master node and a source secondary node, configuration data representing (i) configuration information for a secondary cell group associated with the target secondary node and the target master node, and (ii) a value of at least one parameter, the configuration information including an indication that a primary secondary cell of the secondary cell group remains the same before an execution of the conditional handover, the at least one parameter causing the user equipment to control reporting of a radio link failure at the secondary cell group after the execution of the conditional handover has begun. Operation 720 includes detecting, by the user equipment, a radio link failure at the secondary cell group. Operation 730 includes, after detecting the radio link failure, performing, by the user equipment, measurements of a signal quality metric at the secondary cell group.

Example 2-2: According to an example implementation of example 2-1, wherein the parameter includes an indication indicating that the user equipment shall not report the radio link failure at the secondary cell group in response to the detection of the radio link failure at the secondary cell group occurring prior to the execution of the conditional handover.

Example 2-3: According to an example implementation of examples 2-1 or 2-2, wherein the parameter includes an amount of time for the user equipment to wait to receive new configuration data for the secondary cell group after which the user equipment transmits a RRC Reconfiguration Complete message to the master target node.

Example 2-4: According to an example implementation of example 2-3, wherein the amount of time is based on an estimate of an amount of time taken for a target primary cell to send a new RRC Reconfiguration message to the user equipment.

Example 2-5: According to an example implementation of example 2-4, further comprising transmitting reconfiguration complete data to the master target node, the reconfiguration complete data representing a RRC Reconfiguration Complete message; in response to receiving new configuration data from the target master node within the amount of time from the transmission of the reconfiguration complete data to the master target node, the new configuration data representing a new configuration of the secondary cell group, performing a random access operation to access the target secondary node; and in response to not receiving new configuration data from the target master node within the amount of time from the transmission of the reconfiguration complete data to the master target node, performing an evaluation of a signal quality metric at the secondary cell group.

Example 2-6: According to an example implementation of example 2-5, wherein the parameter includes a signal quality threshold as measured by the user equipment at a primary secondary cell.

Example 2-7: According to an example implementation of example 2-6, wherein the parameter further includes amount of time allotted for the user equipment to add the secondary cell group after the user equipment transmits a RRC Reconfiguration Complete message to the master target node.

Example 2-8: According to an example implementation of example 2-7, further comprising transmitting reconfiguration complete data to the master target node, the reconfiguration complete data representing a RRC Reconfiguration Complete message; in response to not receiving new configuration data from the target master node within the amount of time from the transmission of the reconfiguration complete data to the master target node, perform an evaluation of a signal quality metric at the secondary cell group; in response to the signal quality metric being greater than the signal quality threshold, perform a random access operation to access the target secondary node; and in response to the signal quality metric being less than the signal quality threshold, append a secondary cell group failure report to the RRC Reconfiguration Complete message.

Example 2-9: An apparatus comprising means for performing a method of any of examples 2-1 to 2-8.

Example 2-10: A computer program product including a non-transitory computer-readable storage medium and storing executable code that, when executed by at least one data processing apparatus, is configured to cause the at least one data processing apparatus to perform a method of any of examples 2-1 to 2-8.

### LIST OF EXAMPLE ABBREVIATIONS

HO: HandOver
HOF: HandOver Failure
CHO: Conditional HandOver
MCG: Master Cell Group
MN: Master Node
RACH: Random Access CHannel
RLF: Radio Link Failure
SCG: Secondary Cell Group
SN: Secondary Node
UE: User Equipment

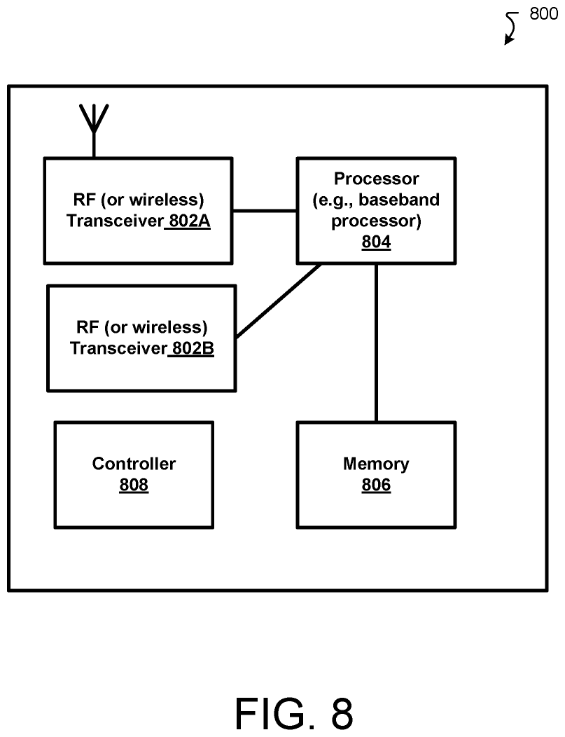

FIG. 8 is a block diagram of a wireless station (e.g., AP, BS, e/gNB, NB-IoT UE, UE or user device) 800 according to an example implementation. The wireless station 800 may include, for example, one or multiple RF (radio frequency) or wireless transceivers 802A, 802B, where each wireless transceiver includes a transmitter to transmit signals (or data) and a receiver to receive signals (or data). The wireless station also includes a processor or control unit/entity (controller) 804 to execute instructions or software and control transmission and receptions of signals, and a memory 806 to store data and/or instructions.

Processor 804 may also make decisions or determinations, generate slots, subframes, packets or messages for transmission, decode received slots, subframes, packets or messages for further processing, and other tasks or functions described herein. Processor 804, which may be a baseband processor, for example, may generate messages, packets, frames or other signals for transmission via wireless transceiver 802 (802A or 802B). Processor 804 may control transmission of signals or messages over a wireless network, and may control the reception of signals or messages, etc., via a wireless network (e.g., after being down-converted by wireless transceiver 802, for example). Processor 804 may be programmable and capable of executing software or other instructions stored in memory or on other computer media to perform the various tasks and functions described above, such as one or more of the tasks or methods described above. Processor 804 may be (or may include), for example, hardware, programmable logic, a programmable processor that executes software or firmware, and/or any combination of these. Using other terminology, processor 804 and transceiver 802 together may be considered as a wireless transmitter/receiver system, for example.

In addition, referring to FIG. 8, a controller (or processor) 808 may execute software and instructions, and may provide overall control for the station 800, and may provide control for other systems not shown in FIG. 8 such as controlling input/output devices (e.g., display, keypad), and/or may execute software for one or more applications that may be provided on wireless station 800, such as, for example, an email program, audio/video applications, a word processor, a Voice over IP application, or other application or software.

In addition, a storage medium may be provided that includes stored instructions, which when executed by a controller or processor may result in the processor 804, or other controller or processor, performing one or more of the functions or tasks described above.

According to another example implementation, RF or wireless transceiver(s) 802A/802B may receive signals or data and/or transmit or send signals or data. Processor 804 (and possibly transceivers 802A/802B) may control the RF or wireless transceiver 802A or 802B to receive, send, broadcast or transmit signals or data.

The embodiments are not, however, restricted to the system that is given as an example, but a person skilled in the art may apply the solution to other communication systems. Another example of a suitable communications system is the 5G concept. It is assumed that network architecture in 5G will be quite similar to that of the LTE-advanced. 5G uses multiple input—multiple output (MIMO) antennas, many more base stations or nodes than the LTE (a so-called small cell concept), including macro sites operating in co-operation with smaller stations and perhaps also employing a variety of radio technologies for better coverage and enhanced data rates.

It should be appreciated that future networks will most probably utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations may be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Implementations may also be provided on a computer readable medium or computer readable storage medium, which may be a non-transitory medium. Implementations of the various techniques may also include implementations provided via transitory signals or media, and/or programs and/or software implementations that are downloadable via the Internet or other network(s), either wired networks and/or wireless networks. In addition, implementations may be provided via machine type communications (MTC), and also via an Internet of Things (IoT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers.

Furthermore, implementations of the various techniques described herein may use a cyber-physical system (CPS) (a system of collaborating computational elements controlling physical entities). CPS may enable the implementation and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various implementations of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, implementations may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall as intended in the various embodiments.

1. An apparatus, comprising:
at least one processor; and
at least one memory including computer program code;
the at least one memory and the computer program code configured to cause the apparatus at least to:
transmit, by a source master node within a network to a target master node within the network, request data representing a request to prepare execution of a conditional handover involving a user equipment served by the source master node and a source secondary node;
receive, by the source master node from the target master node, response data representing configuration information for a secondary cell group associated with a target secondary node and the target master node, the configuration information including an indicator indicating that a primary secondary cell of the secondary cell group remains the same after the execution of the conditional handover;
transmit, by the master source node to the user equipment, configuration data representing (i) the configuration information for the secondary cell group and (ii) a value of at least one parameter, the at least one parameter causing the user equipment to control reporting of a radio link failure at the secondary cell group and before the execution of the conditional handover has begun;
after transmitting the configuration data to the user equipment, receive, by the source master node from the user equipment, failure data indicating that the user equipment detected a radio link failure at the secondary cell group; and
determine, by the source master node, an action to take to respond to the detected radio link failure at the secondary cell group, the action being based on the configuration information for the secondary cell group.

2. The apparatus as in claim 1, wherein the action includes forwarding the failure data to the target master node.

3. The apparatus as in claim 1, wherein the action includes forwarding the failure data to the source secondary node, which is the same as target secondary node.

4. The apparatus as in claim 1, wherein the action includes discarding the failure data.

5. The apparatus as in claim 1, wherein the failure data includes measurement data representing measurements of the primary secondary cell performed by the user equipment, the measurements being made by the user equipment after the user equipment detected the radio link failure at the secondary cell group.

6. The apparatus as in claim 1, wherein the parameter includes an indication indicating that the user equipment shall not report the radio link failure at the secondary cell group in response to the detection of the radio link failure at the secondary cell group occurring prior to the execution of the conditional handover.

7. The apparatus as in claim 1, wherein the parameter includes an amount of time allotted for the user equipment to receive new configuration data for the secondary cell group after the user equipment sends a RRC Reconfiguration Complete message to the master target node.

8. The apparatus as in claim 7, wherein the amount of time is based on an estimate of an amount of time taken for a target primary cell to send a new RRC Reconfiguration message to the user equipment.

9. The apparatus as in claim 1, wherein the parameter includes a signal quality threshold as measured by the user equipment at a primary secondary cell.

10. The apparatus as in claim 1, wherein the configuration information for the secondary cell group indicates support for the secondary node for a change in a configuration of the secondary cell group.

11. The apparatus as in claim 1, wherein any of (i) the parameter including an amount of time allotted for the user equipment to receive new configuration data for the secondary cell group after the user equipment sends a RRC Reconfiguration Complete message to the master target node, (ii) the parameter including a signal quality threshold as measured by the user equipment at a primary secondary cell, or (iii) the configuration information for the secondary cell group indicating support for the secondary node for a change in a configuration of the secondary cell, occurs in response to a new conditional handover command with updated secondary cell group configuration not being delivered to the user equipment before the conditional handover is executed.

12. The apparatus as in claim 1, wherein the action to take to respond to the detected radio link failure at the secondary cell group is determined based on whether a measurement of the primary secondary cell reported in a secondary cell group failure report is served by the same secondary node as the secondary node to which a source primary secondary cell belongs.

13. A method, comprising:
transmitting, by a source master node within a network to a target master node within the network, request data representing a request to prepare execution of a conditional handover involving a user equipment served by the source master node and a source secondary node;
receiving, by the source master node from the target master node, response data representing configuration information for a secondary cell group associated with a target secondary node and the target master node, the configuration information including an indicator indicating that a primary secondary cell of the secondary cell group remains the same after an execution of the conditional handover;
transmitting, by the master source node to the user equipment, configuration data representing (i) the configuration information for the secondary cell group and (ii) a value of at least one parameter, the at least one parameter causing the user equipment to control reporting of a radio link failure at the secondary cell group and after the execution of the conditional handover has begun;
after transmitting the configuration data to the user equipment, receiving, by the source master node from the user equipment, failure data indicating that the user equipment detected a radio link failure at the secondary cell; and
determining, by the source master node, an action to take to respond to the detected radio link failure at the secondary cell group, the action being based on the configuration information for the secondary cell group.

14. An apparatus, comprising:
at least one processor; and
at least one memory including computer program code;
the at least one memory and the computer program code configured to cause the apparatus at least to:
receive, by a user equipment served by a source master node and a source secondary node as part of a conditional handover to a target master node and a source secondary node, configuration data representing (i) configuration information for a secondary cell group associated with the target secondary node and the target master node, and (ii) a value of at least one parameter, the configuration information including an indication that a primary secondary cell of the secondary cell group remains the same before an execution of the conditional handover, the at least one parameter causing the user equipment to control reporting of a radio link failure at the secondary cell group after the execution of the conditional handover has begun;
detect, by the user equipment, a radio link failure at the secondary cell group; and
after detecting the radio link failure, perform, by the user equipment, measurements of a signal quality metric at the secondary cell group.

15. The apparatus as in claim 14, wherein the parameter includes an indication indicating that the user equipment shall not report the radio link failure at the secondary cell group in response to the detection of the radio link failure at the secondary cell group occurring prior to the execution of the conditional handover.

16. The apparatus as in claim 14, wherein the parameter includes an amount of time for the user equipment to wait to receive new configuration data for the secondary cell group after the user equipment transmits a RRC Reconfiguration Complete message to the master target node.

17. The apparatus as in claim 16, wherein the amount of time is based on an estimate of an amount of time taken for a target primary cell to send a new RRC Reconfiguration message to the user equipment.

18. The apparatus as in claim 17, wherein the at least one memory and the computer program code are further configured to cause the apparatus at least to:
transmit reconfiguration complete data to the master target node, the reconfiguration complete data representing a RRC Reconfiguration Complete message;
in response to receiving new configuration data from the target master node within the amount of time from the transmission of the reconfiguration complete data to the master target node, the new configuration data representing a new configuration of the secondary cell group, perform a random access operation to access the target secondary node; and
in response to not receiving new configuration data from the target master node within the amount of time from the transmission of the reconfiguration complete data to the master target node, perform an evaluation of a signal quality metric at the secondary cell group.

19. The apparatus as in claim 14, wherein the parameter includes a signal quality threshold as measured by the user equipment at a primary secondary cell.

20. The apparatus as in claim 19, wherein the parameter further includes amount of time allotted for the user equipment to add the secondary cell group after the user equipment transmits a RRC Reconfiguration Complete message to the master target node.

21-31. (canceled)
